(19) United States
(12) Patent Application Publication
(10) Pub. No.: US 2012/0247005 A1
(43) Pub. Date: Oct. 4, 2012

(54) METHOD AND REACTOR FOR PROCESSING BULK MATERIAL CONTAINING Li

(76) Inventors: Hubert Jaeger, Zusamaltheim (DE); Johann Daimer, Morfelden-Walldorf (DE)

(21) Appl. No.: 13/501,478

(22) PCT Filed: Oct. 15, 2010
(86) PCT No.: PCT/EP2010/065572

§ 371 Date: Jun. 1, 2012

(30) Foreign Application Priority Data
Oct. 14, 2009 (DE) 10 2009 049 423.5

(51) Int. Cl. C22B 26/12; C10L 5/00; B01J 14/00

(52) U.S. Cl. 44/605; 422/199; 423/179.5; 75/300

(57) ABSTRACT

The invention relates to a method for recovering lithium from a starting material comprising lithium. According to the invention, the starting material is heated with carbon in a reactor by carrying out direct inductive heating of the carbon.

The invention relates to a method for refining a starting material containing lithium and to a reactor for carrying out the method.

As the use of lithium ions is increasing greatly, the demand for lithium is increasing constantly. At the same time, there is a need to provide an effective process for recycling Li ion batteries. This necessity is amplified due to the harmfulness to the health of lithium and its compounds.

Previous trials to refine battery waste containing Li and to reclaim the lithium contained therein concentrated on chemical processing variants. Such methods were described, for example, in U.S. Pat. No. 6,835,228 or U.S. Pat. No. 6,514,311. However, a plurality of reaction steps associated with the corresponding quantity of chemicals is required for this purpose.

It is the object of the present invention to provide a technically simple method with which lithium can be reclaimed from a starting material containing lithium, in particular from bulk material, in particular from lithium ion batteries, wherein in particular few chemical reaction steps are necessary.

The object is satisfied by all features of the method in accordance with claim 1. Further developments of the method in accordance with the invention are set forth in the dependent claims 2 to 13.

It is essential to the invention that a starting material containing lithium is heated in a reactor with carbon in that the carbon is directly inductively heated.

High temperatures which facilitate a reclaiming of lithium can be produced with great efficiency by inductive heating. Chemical extraction thereby becomes unnecessary.

The starting material advantageously contains bulk material. Bulk material is easy to introduce into a reactor and is easy to remove from the reactor after a purifying of lithium. Battery waste can, for example, be present as bulk material. The starting material containing Li is advantageously formed by bulk material.

The lithium in the starting material and/or bulk material can be present in a metallic form and/or in ionic form, for example as an organic and/or inorganic compound. On the presence of the lithium in the form of ions, the carbon in the bulk material can serve as a reductant so that metallic lithium arises in the method in accordance with the invention.

A direct inductive heating is possible in that carbon has such an electric conductivity that frequencies of an induction heating can couple into the carbon and can heat it directly without a coupling into an additional medium being necessary. Furthermore, a reactor wall does not have to be heated, which has the consequence of only a small heat loss via the reactor wall and thus a very high energy efficiency of the method.

Reclamation of lithium is understood within the framework of the invention as a removal of lithium from the bulk material, wherein the lithium is present separately from the bulk material after carrying out the method. In this respect, the lithium does not have to be present in metallic form after reclamation. It is sufficient to have the lithium present in highly concentrated form, for example in a chemical compound such as a hydroxide or a salt.

Bulk material containing Li is advantageously refined by the method. Refining is understood within the framework of the invention as a treatment of bulk material containing carbon with which lithium is removed from the bulk material, wherein this treatment is carried out to the extent that this bulk material can be stored in landfill sites, can be reused as a resource and/or can be used as a fuel without risk to the environment or to people.

The starting material preferably contains waste from batteries containing lithium ions. Such waste arises, for example, in the waste disposal of spent so-called lithium ion storage batteries, briefly called Li ion storage batteries.

The directly inductively heatable carbon can be of varying provenience. Li ion storage batteries are preferably refined using the method in accordance with the invention in which lithium ions are embedded as intercalation compounds in carbon, in particular graphite. In this case, the carbon of the Li ion storage batteries themselves can be directly inductively heated.

Carbon can already be added to the bulk material which is used in the method in accordance with the invention and/or can be admixed during the method. The carbon of the bulk material can be present, for example, as amorphous carbon, natural graphite, synthetic graphite or in any other desired form. An inductive coupling only has to be able to take place at at least a portion of the carbon.

In an advantageous case, the starting material is formed as a bulk material such that the bulk material can be directly inductively heated without the adding of additional carbon which can be directly inductively heated. This can be the case, for example, if Li ion storage batteries having a graphite anode are used. Such Li ion storage batteries are broken or are at least mechanically opened and used as bulk material. A separation of disturbing components such as sheet metal jackets may take place before the use as a bulk material. If relatively small storage batteries having sizes of only a few centimeters are present, relatively high induction frequencies may, however, be necessary for heating the bulk material. It may furthermore be necessary, due to smaller penetration depths with small grain sizes and high frequencies, to use reactors which only have a very small size of, for example, less than 20 cm diameter.

Carbon which facilitates a coupling of induction fields into the bulk material is advantageously added to the starting material. This makes it possible, for example, to use a starting material containing Li, such as bulk material contaminated with Li, which has a small carbon content, such as lithium batteries which contain metallic lithium. It is even possible to use a starting material contaminated with Li which is originally completely free of carbon. In this variant, sufficient carbon must be added to the starting material that an inductive heating is possible.

Bulk material is advantageously used of which more than 50% by weight has a grain size of more than 30 mm, in particular of which more than 50% by weight has a grain size between 50 and 150 mm. With such grain sizes, it has been found within the framework of the invention that inductive fields couple very easily into the bulk material. Such high grain sizes furthermore have the advantage that complex, and thus energy-intensive and cost-intensive, grinding steps are not necessary, but rather relatively coarsely broken bulk material can be used. The named grain sizes can have both bulk material containing carbon having the lithium to be reclaimed and also carbon which is added/is to be added to the bulk material.

In this respect, however, a fine fraction of less than 50 mm, in particular less than 30 mm, in particular less than 10 mm, can remain in the bulk material. Even a fine fraction present as dust can remain in the bulk material. The fine fraction is indirectly heated through the coarse fraction. This makes a separation of the fine fraction and the coarse fraction of the bulk material before the carrying out of the method in accordance with the invention unnecessary.

Induction fields having frequencies between 1 and 50 kHz, in particular between 1 and 10 kHz, in particular between 2 and 5 kHz, are advantageously generated. At these low frequencies, the induction fields couple particularly easily into coarse grains and have a large penetration depth into the bulk material so that large reactor diameters can be used.

Maximum temperatures up to 3000° C. can be produced in the reactor. This is possible by the direct coupling of the induction fields into the carbon in the reactor. Maximum temperatures above 1100° C., in particular between 1200 and 1800° C., in particular between 1250 and 1500° C., are preferably set in the reactor. With a boiling point of 1342° C., lithium already has a vapor pressure at temperatures above 1100° C., in particular above 1200° C., in particular above 1250° C., which is high enough that lithium enters into the gas phase and is thus removed from the starting material.

Bulk material purified of lithium can advantageously slide into a lower zone of the reactor from where it can be removed. The method can thereby be carried out continuously. A removal can be carried out by means of a pusher and/or of a crusher. After the removal, the bulk material advantageously slides on into the lower zone. The lower zone can be designed so that no induction coils are present. The bulk material can thereby cool in this region and is better to handle after the removal. An active cooling can additionally be provided.

Batteries containing Li to be refined in the bulk material can contain further metals which are present, for example, as electrode parts in metallic form. They can be separated from the bulk material and from one another after a removal of the bulk material purified from lithium from the reactor, for example by means of density separation processes such as flotation processes or screening.

At least a portion of the lithium is preferably converted into a gas phase. This allows a removal of the lithium from the starting material and a transport and a collection of the lithium.

The lithium converted into a gaseous phase is advantageously precipitated with a liquid, in particular water. This allows a binding and thus a collecting of the lithium.

Water can be introduced in at least one zone of the reactor, such as a gas space in an upper zone, in liquid form or as water vapor. This can take place by atomization or nebulization. The introduction of water can advantageously satisfy a plurality of functions. Water can, for example, bind lithium and contribute to the cooling.

Lithium is advantageously in particular converted to lithium hydroxide (LiOH) with water. LiOH is not toxic, is chemically stable and easy to store. The purified bulk material can advantageously be reused after the removal. It can be used as fuel and as a resource, such as for carburization in the steel industry.

Lithium converted into a gaseous phase is advantageously precipitated with a liquid, in particular water. A precipitation of gaseous compounds advantageously takes place spatially separate from the reactor space, for example in a gas scrubber, such as a scrubber tower, which is connected to the reactor space.

The object of the present invention is furthermore satisfied by the features of the reactor in accordance with claim 14. Advantageous further developments are set forth in the dependent claims 15 to 25.

The reactor has induction coils which are suitable to heat carbon and/or the bulk material containing carbon directly inductively.

The induction coils are advantageously suitable to set a predefined temperature gradient in the radial and/or axial direction of the reactor. A temperature gradient can be used directly to control the method in accordance with the invention.

The induction coils are advantageously suited to heat the starting material and/or the bulk material without temperature gradients or with a low temperature gradient. In particular a radial temperature gradient is possible which is smaller than 100 K/m, in particular smaller than 50 K/m, in particular smaller than 30 K/m.

The reactor advantageously has a high temperature resistant inner wall into which the induction fields generated by the induction coils at the frequencies used for heating the carbon and/or the bulk material containing carbon do not couple or at least hardly couple. This reduces the temperature load of the inner wall and considerably extends its life expectancy with respect to conventional heatings.

The inner wall can have a lining which contains at least one material from the group comprising carbon, oxidic refractory materials, non-oxidic refractory materials and chamotte.

The lining advantageously comprises clay-bound graphite. Despite the high carbon content, clay-bound graphite has such a low electric conductivity that it cannot be inductively heated.

The reactor advantageously has a reactor space which has an upper zone, a middle zone and a lower zone in the axial direction, with the reactor in particular being able to be designed such that starting material to be purified from lithium and/or bulk material to be refined can be introduced into the upper zone, the middle zone is provided with the induction coils extending at least partly around the reactor and purified bulk material accumulates in the lower zone and can be removed from it. A continuous process can thus be carried out with the reactor.

The reactor advantageously has a diameter of more than 50 cm in the region of the induction coils to achieve a throughput which is as high as possible. The diameter is advantageously larger than 75 cm, in particular between 1 m and 1.5 m, Such a large reactor in conjunction with the direct inductive heating in accordance with the invention allows high throughput quantities. The starting material or the bulk material is heated considerably faster by the process of inductive heating in conjunction with low frequencies and coarse grain size of the carbon or of the bulk material containing carbon than by conventional heating, which allows an energy-efficient and cost-efficient treatment.

The reactor can expand conically downwardly in the lower zone and/or in a lower region of the middle zone. This facilitates a downward sliding of bulk material.

The reactor advantageously has a loading lock such as a cell wheel lock via which the reactor can be supplied with starting material and/or bulk material, with the loading lock being suitable to prevent an uncontrolled escape of gases, in particular of gaseous lithium, from the reactor.

Furthermore, a gas scrubber connected to the reactor space such as a scrubber tower can be provided which is suitable to wash out lithium converted into a gaseous phase using a liquid such as water. Gaseous lithium from the gas phase can in particular be bound by liquid in the gas scrubber and can condense in the gas scrubber due to a low temperature. Further processes, in particular chemical processes, can run in the gas scrubber. For instance, lithium can react to lithium hydroxide and can be subsequently filtered off.

At least one injection apparatus can advantageously be provided in the reactor which is suitable to introduce water and/or water vapor into the reactor space in at least one of the upper, middle and lower zones.

At least one induction coil is advantageously cooled. Since the induction fields do not couple into the reactor wall, the latter is not heated directly and therefore does not have to be actively cooled. The reactor wall is, however, advantageously cooled by convection.

Further advantageous aspects and further developments of the invention will be explained in the following with reference to a preferred embodiment and to an associated Figure.

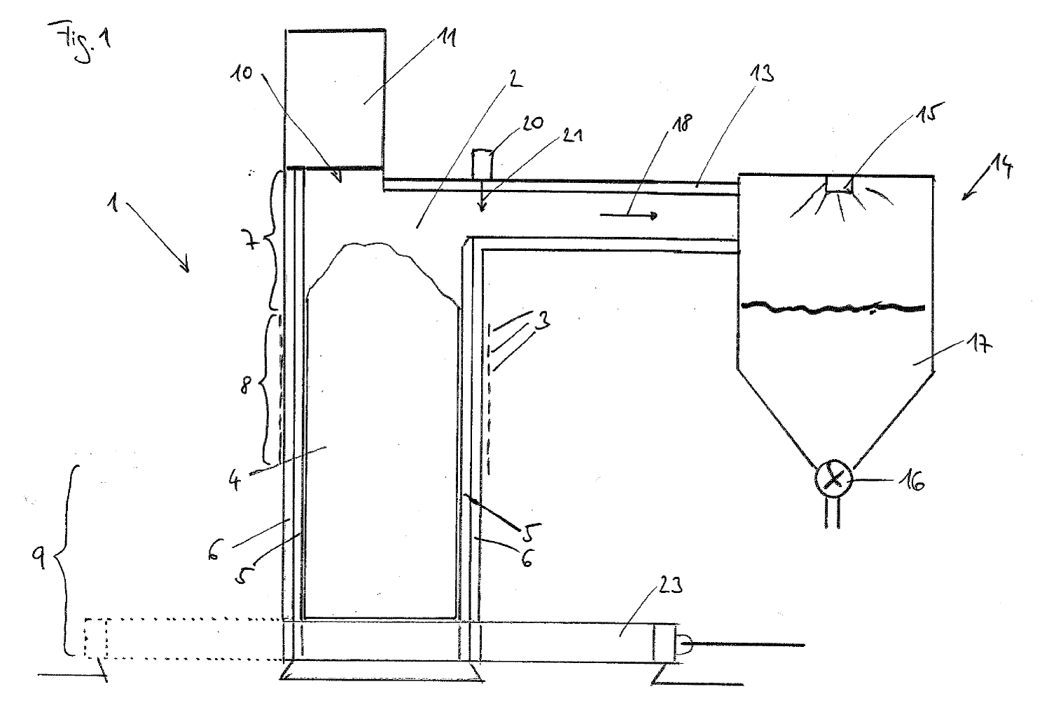

In this respect, FIG. 1 shows a schematic representation of a reactor in accordance with the invention.

A reactor 1 in accordance with the invention has, in accordance with the embodiment, a reactor space 2 having a diameter of 1.5 m around which induction coils 3 are arranged which at least partly surround the reactor space 2 and which are suitable to heat a bulk material 4 containing carbon present in the reactor space 2 to temperatures of up to 1800° C. at frequencies between 1 and 50 kHz. The reactor space 2 is surrounded by a high temperature resistant lining 5 of a reactor wall 6. In this embodiment, the lining 5 comprises chamotte bricks. However, all other high temperature resistant materials are suitable into which a field generated by the induction coils 3 does not couple, such as clay-bound carbon. The reactor 1 has an upper zone 7, a middle zone 8 and a lower zone 9.

A filler opening 10 is provided at the upper zone 7 and bulk material 4 as starting material containing Li, carbon, and optionally additives, can be poured into the reactor space 2 via it. To prevent an escape of lithium from the reactor space 2, a cell wheel lock is placed onto the filler opening 10 as a loading lock 11.

The induction coils 3 are provided in the middle zone 8. A pusher 23 is provided in the lower zone 9 which acts as a crusher for crushing bulk material 4 and/or for its removal.

The upper zone 7 is provided with a connection piece 13 which connects the reactor space 2 to a scrubber tower 14 which acts as a gas scrubber 14. At least one water nozzle 15 is provided in the scrubber tower 14 to inject water into the scrubber tower 14. Collected water 17 can be let out via a valve 16.

Bulk material 4 together with lumpy carbon is poured into the reactor space 2 via the cell wheel lock 11 for operating the reactor 1. The bulk material 4 and additional carbon can also be added as individual components. The bulk material 4 in this example contains spent Li ion storage batteries in which lithium is present as an intercalation compound in graphite.

The induction coils 3 directly inductively heat the bulk material 4 containing Li in that the induction fields couple directly into the carbon of the Li ion storage batteries as well as into the added carbon. The embedded lithium compounds are also heated via the carbon of the heated bulk material 4. Organic solvents originating from the bulk material are evaporated by the heating and prevent a supply of air, that is of oxygen and nitrogen, due to the accompanying volume increase. An oxidation of metallic lithium, but also a nitrogen formation, for example, is thereby also prevented. The solvents degrade and generate a reducing atmosphere which, in addition to the carbon of the bulk material, additionally contributes to a reduction of the lithium compounds to metallic lithium. Liquid lithium arises in the middle zone 8 which already changes from the liquid phase into the gas phase at temperatures from 1100° C., in particular 1200° C., in particular 1250° C., due to its high vapor pressure.

The gaseous lithium moves via the connection piece 13 into the scrubber tower 14 due to the volume expansion and convection. The lithium is cooled, liquefied and converted to LiOH by water trickling out of the water nozzle 15. A volume reduction thereby takes place which assists a gas flow from the reactor 2 into the scrubber tower 14 which is shown by an arrow 18 in FIG. 1.

Water vapor 21 can be injected into the upper zone 7 into the reactor space 2 to move a reaction of lithium forward into the reactor space.

The bulk material purified from lithium cools in the lower zone 9, that is outside an effective region of the induction coils 3. The bulk material is removed from the lower zone 9 via the pusher 23. The purified bulk material containing carbon can be used as a fuel or as a resource, for instance for carburization in the steel industry.

Washed out lithium, in particular lithium present as a hydroxide, can be removed via the valve 16 together with water 17 of the scrubber tower 14. The lithium can optionally be supplied to any desired conventional use, for example for Li ion batteries, after a corresponding refining.

In a further example, the method in accordance with the invention is carried out using bulk material containing lithium from Li ion storage batteries, with more than 50% of the grains having sizes between 30 and 100 mm. Since the generated induction fields already couple very easily into the battery waste, no additional addition of lumpy carbon is necessary in this example.

In yet a further example, the battery waste containing Li originates exclusively from batteries which operate free of carbon. In this case, the induction fields only coupled into additionally added lumpy carbon having grain sizes between 30 and 150 mm, and the battery waste containing Li is indirectly inductively heated.

The efficiency of the method and of the reactor in accordance with the invention was thus clearly demonstrated.

All the features named in the description, in the examples and in the claims can contribute to the invention in any desired combination. The lithium can in particular be in bulk material of any provenience and the carbon into which induction fields can couple can already be contained in the battery waste itself and/or can additionally be added to the bulk material.

1.-26. (canceled)

27. A method of reclaiming lithium from a starting material containing lithium, comprising the step of heating the starting material with carbon in a reactor in which the carbon is directly inductively heated.

28. The method in accordance with claim 27, wherein the starting material contains carbon which is suitable to be directly inductively heated.

29. The method in accordance with claim 27, wherein the carbon, which is suitable to be directly inductively heated, is added to and/or is to be added to the starting material.

30. The method in accordance with claim 27, wherein the starting material and/or the bulk material contain(s) waste from batteries containing lithium ions.

31. The method in accordance with claim 27, wherein bulk material is used of which more than 50% by weight has a grain size of more than 30 mm.

32. The method in accordance with claim 27, wherein bulk material is used of which more than 50% by weight has a grain size of between 50 and 150 mm.

33. The method in accordance with claim 27, wherein the step of heating is carried out inductively at frequencies between 1 and 50 kHz.

34. The method in accordance with claim 27, wherein maximum temperatures are set in the reactor between 1100° C. and 3000° C.

35. The method in accordance with claim 27, wherein lithium converted into a gaseous phase is precipitated with a liquid.

36. The method in accordance with claim 27, wherein water and/or water vapor is introduced in at least one zone of the reactor.

37. A reactor for carrying out a method of reclaiming lithium from a starting material containing lithium, wherein the reactor comprises induction coils which are suitable to heat the carbon directly inductively.

38. The reactor in accordance with claim 37, wherein the induction coils are suitable to heat the starting material with a radial temperature gradient which is less than 100 K/m.

39. The reactor in accordance with claim 37, wherein the reactor further comprises a high temperature resistant inner wall into which the induction fields generated by the induction coils at the frequencies used for heating the bulk material do not couple or at least hardly do not couple.

40. The reactor in accordance with claim 37, wherein the inner wall has a lining which contains at least one material from the group comprising carbon, oxidic refractory materials, non-oxidic refractory materials and chamotte.

41. The reactor in accordance with claim 40, wherein the lining comprises clay-bound graphite.

42. The reactor in accordance with claim 37, wherein the reactor has a reactor space which has an upper zone, a middle zone and a lower zone in the axial direction, with the middle zone being provided with the induction coils extending at least partly around the reactor and purified bulk material accumulating in the lower zone and wherein the purified bulk material can be removed from it.

43. The reactor in accordance with claim 37, wherein the reactor has a diameter in the region of the induction coils of more than 50 cm.

44. The reactor in accordance with claim 37, wherein the reactor further comprises a loading lock via which the reactor can be supplied with starting material, with the loading lock being suitable to prevent an uncontrolled escape of gases from the reactor.

45. The reactor in accordance with claim 37, wherein a gas scrubber connected to the reactor space is provided which is suitable to precipitate lithium transferred into a gaseous phase with a liquid.

46. The reactor in accordance with claim 37, wherein at least one injection apparatus is provided which is suitable to introduce water and/or water vapor into the reactor space in at least one of the upper, middle and lower zones.

47. A bulk material containing carbon purified using a method of reclaiming lithium from a starting material containing lithium, said method comprising the step of heating the starting material with carbon in a reactor, in which the carbon is directly inductively heated, as a fuel or as a resource.
